(19) United States
(12) Patent Application Publication
(10) Pub. No.: US 2008/0189938 A1
(43) Pub. Date: Aug. 14, 2008

(54) Terminal inserting tool set, terminal inserting apparatus and method of inserting terminal

(75) Inventor: Mamoru Araki, Makinohara (JP)

Correspondence Address: Edwards Angell Palmer & Dodge LLP, P.O. Box 55874, Boston, MA, 02205, US

(73) Assignee: Yazaki Corporation, Tokyo (JP)

(21) Appl. No.: 12/010,945

(22) Filed: Jan. 31, 2008

(30) Foreign Application Priority Data
Feb. 13, 2007 (JP) 2007-031922

(51) Int. Cl. H01R 43/00

(52) U.S. Cl. 29/747; 29/857; 29/748

(57) ABSTRACT

Providing a terminal inserting tool set to be miniaturized, a terminal inserting apparatus to be miniaturized and a method for inserting terminals, the terminal inserting apparatus includes a terminal chain supply unit, a support unit and a terminal inserting tool set. The terminal chain supply unit supplies a terminal chain. The terminal chain has multiple terminals arranged with even intervals to each other and a joint connecting continuously the terminals to each other in a row. The support unit supports a terminal set jig. The terminal inserting tool set includes a guide tool, a positioning tool, cutting tools and an inserting tool. The guide tool and the positioning tool position the terminal chain. The cutting tools separate at least one terminal from the terminal chain. The inserting tool inserts the at least one terminal into a receiving section of the terminal set jig.

The priority application Number Japan Patent Application 2007-031922 upon which this patent application is based is hereby incorporated by reference.

### BACKGROUND OF THE INVENTION

1. Field of the Invention

This invention relates to a terminal inserting tool set, which separates a terminal from a terminal chain and inserts the separated terminal into a receiving section of a terminal holding member, such as a connector housing and a terminal set jig, and a terminal inserting apparatus with the terminal inserting tool set.

2. Description of the Related Art

An automobile as a movable body has a wiring harness for supplying electric power from a battery to an electronic device, for example various lamps mounted thereon and various motors. The wiring harness includes multiple wires, multiple terminals joined with respective ends of the wires and a connector housing provided with receiving sections as a terminal holding member.

The connector housing and the terminals form a connector. The wiring harness generally includes the multiple connectors. The wiring harness is assembled by joining the wires respectively to the terminals after mounting the terminals in the connector housing.

For inserting the terminals into the receiving sections of the connector housing, usual various apparatuses are used. The usual terminal inserting apparatus includes a tool set for separating respective terminals from a terminal chain, in which the multiple terminals are chained with even intervals, and inserting the each terminal into each one of multiple receiving sections.

Usual terminal inserting apparatus separates each terminal from the terminal chain in a condition that a lengthwise direction of the terminal is aligned parallel into a horizontal direction, and stands the separated terminal so as to make the lengthwise direction of the terminal parallel to a vertical direction, and inserts the each terminal respectively into the receiving section of the connector housing.

### SUMMARY OF THE INVENTION

### Objects to be Solved

As mentioned above, the usual terminal inserting apparatus turns the terminal separated from the terminal chain 90 degree and stands the terminal, thereafter inserts the terminal into the receiving section. Thus, since a mechanism for turning the terminal separated from the terminal chain 90 degree is required, the mechanism and a structure of the tool set for separating the terminal from the terminal chain are complicated, and the usual terminal inserting apparatus becomes large.

According to the above problem, an object of the present invention is to provide a terminal inserting tool set to be miniaturized, a terminal inserting apparatus to be miniaturized and a method of inserting terminals.

### HOW TO ATTAIN THE OBJECT OF THE PRESENT INVENTION

In order to overcome the above problems and attain the object of the present invention, a terminal inserting tool set for inserting respectively terminals, which are supplied to the tool set in a form of a terminal chain including the multiple terminals and a joint for connecting continuously the terminals to each other in a row, into respective receiving sections of a terminal holding member according to the present invention includes a guide tool positioning the terminal chain so as to align lengthwise directions of the terminals in parallel with a vertical direction; a pair of cutting tools arranged to freely move close to and apart from each other along an intersect direction intersecting both the lengthwise directions of the terminals and a direction of the row of the terminals, the pair of cutting tools separating at least one terminal of the terminals from the terminal chain by placing the at least one terminal between the pair of cut tools and moving the at least one terminal along the intersect direction; and an inserting tool inserting the at least one terminal separated from the terminal chain by the cutting tools into at least one of the receiving sections of the terminal holding member.

The terminal inserting tool set according to the present invention is further characterized of including a positioning tool positioning the terminal chain by holding the terminal chain between the positioning tool and the guide tool.

A terminal inserting apparatus according to the present invention includes an apparatus main body; a supporting unit provided in the apparatus main body and supporting the terminal holding member; the aforesaid terminal inserting tool set arranged above the supporting unit and inserting the at least one terminal into the one of at least one receiving section of the receiving sections of the terminal holding member; and an actuating unit actuating the terminal inserting tool set.

A method of inserting terminals according to the present invention for inserting respectively the terminals into respective receiving sections of a terminal holding member includes the steps of supplying the terminals in a form of a terminal chain having the multiple terminals and a joint for connecting continuously the terminals to each other in a row; positioning the terminal chain so as to align lengthwise directions of the terminals in parallel with a vertical direction; moving at least one terminal of the terminals along an intersect direction intersecting both the lengthwise directions of the terminals and a direction of the row of the terminals; separating the at least one terminal from the terminal chain; and inserting the at least one terminal into at least one of the receiving sections of the terminal holding member.

The above and other objects and features of this invention will become more apparent from the following description taken in conjunction with the accompanying drawings.

### BRIEF DESCRIPTION OF THE DRAWINGS

FIG. 1 is a partially sectional front view of an embodiment of a terminal inserting apparatus according to the present invention;

FIG. 2 is a partially sectional front view showing a cylinder rod for positioning in an extended condition of the terminal inserting apparatus shown in FIG. 1;

FIG. 3 is a partially sectional front view showing the other of cylinder rods for a pair of cutting tools in an extended condition of the terminal inserting apparatus shown in FIG. 2;

FIG. 4 is a partially sectional front view showing the pair of cutting tools separating a terminal from a terminal chain in the terminal inserting apparatus shown in FIG. 3;

FIG. 5 is a partially sectional front view showing the cylinder rods for the pair of cutting tools in a slightly shortened back condition from the extended condition of the terminal inserting apparatus shown in FIG. 4;

FIG. 6 is a partially sectional front view showing a cylinder rod for a inserting tool in an extended condition of the terminal inserting apparatus shown in FIG. 5; and

FIG. 7 is a plan view of the terminal chain having the terminals to be inserted into a receiving section of an insertion accepting object in the terminal inserting apparatus shown in FIG. 1.

### DESCRIPTION OF THE PREFERRED EMBODIMENT

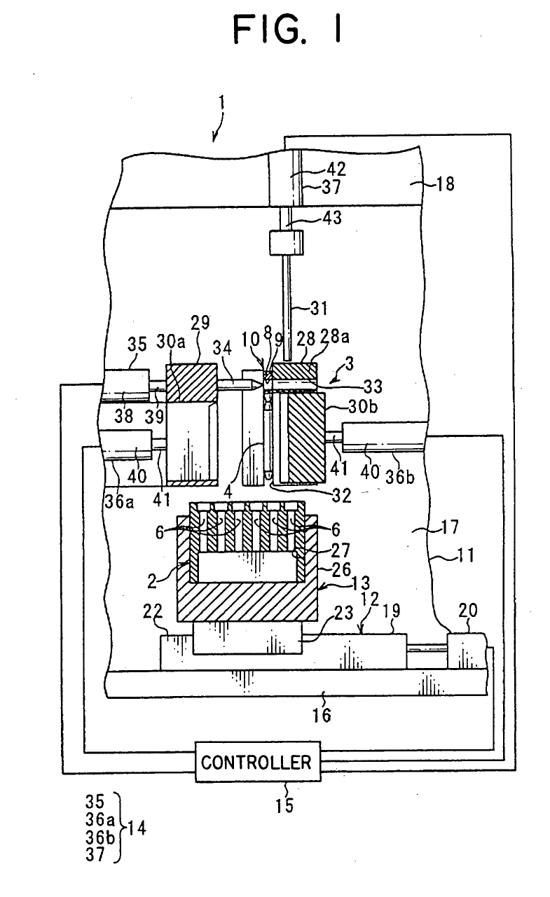

A terminal inserting apparatus 1 of an embodiment according to the present invention will be described with reference to FIGS. 1-8. The terminal inserting apparatus 1, as shown in FIGS. 8A and 8B, is to insert terminals 4 into receiving sections 6 of a terminal set jig 2 as a terminal holding member.

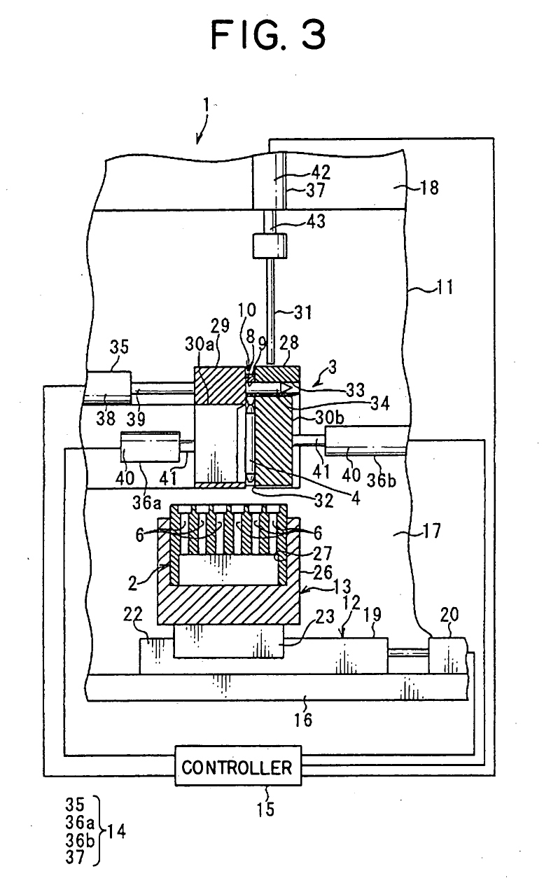

The terminal set jig 2 is made of metal and formed into a rectangular box shape. The terminal set jig 2 is provided with multiple receiving sections 6 to receive a terminal 4. The each receiving section 6 is an opening extending linearly parallel to each other. In this embodiment as shown in FIG. 3, the receiving sections 6 are arranged in parallel to each other in one row. The terminal set jig, in which the terminals 4 are inserted into respective receiving sections 6, is positioned between molding dies in a molding machine so as to place the terminals 4 received in the receiving sections 6 in a cavity of the dies. Thereafter, box main body structuring an electric box is formed together with terminals 4 integrally by insert molding.

The terminal 4 is formed by punching and bending conductive sheet metal. In this embodiment, the terminal 4 is formed into a pin shape. The terminals 4 are set in the terminal set jig 2 so as to be inserted respectively into the receiving sections 6.

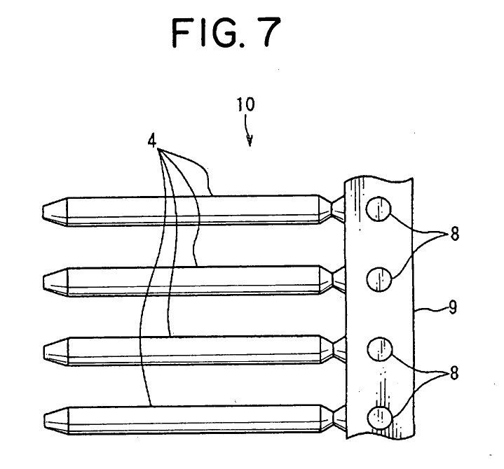

The terminal inserting apparatus 1 shown in FIG. 1 separates the terminals 4 respectively from a terminal chain 10 (shown in FIG. 7), which includes the multiple terminals 4 and a joint 9 for connecting the terminals 4 in a row, and inserts the each terminal 4 into the each corresponding receiving section 6 of the terminal set jig 2. The terminals 4 in the terminal chain 10 are arranged at equal intervals in parallel with each other. The joint 9 continues at one end along a lengthwise direction thereof to one end of the terminal 4 to join the multiple terminals 4 like a chain. A lengthwise direction of the joint 9 intersects a lengthwise direction of the terminal 4 perpendicularly to each other. The joint 9 is provided with multiple round holes 8 for positioning the terminal chain 10. The round holes 8 penetrating through the joint 9 are arranged at equal intervals along the lengthwise direction of the joint 9.

The terminal inserting apparatus 1, as shown in FIG. 1, includes a apparatus main body 11, a terminal chain supply unit (not shown), a slide support unit 12, a support unit 13, a terminal inserting tool set 3 inserting the each terminal 4 into the receiving section 6 of the terminal set jig 2, an actuating unit 14 actuating the terminal inserting tool set 3, and a controller.

The apparatus main body 11, as shown in FIG. 1, includes a base plate 16, a vertical plate 17 extending vertically from the base plate 16, and a horizontal plate 18 connecting with a top end of the vertical plate 17. A top surface of the base plate 16 is formed into a horizontal flat plane. The vertical plate 17 extends vertically from a deep side of the base plate 16 in FIG. 1. A lengthwise direction of the vertical plate 17 is in parallel to a direction intersecting perpendicularly to the top surface of the base plate 16, that is a vertical direction. The horizontal plate 18 extends horizontally from the top end of the vertical plate 17 of the apparatus main body 11 toward this side in FIG. 1. An under surface of the horizontal plate 18 is in parallel with a space to the top surface of the base plate 16.

The terminal chain supply unit, as shown in FIG. 1, supplies the terminal chain 10 to be aligned the lengthwise direction of the joint 9 in parallel to the horizontal direction above the base plate 16 from the deep side in FIG. 1 toward this side in FIG. 1. The terminal chain 10 supplied by the terminal chain supply unit is positioned so as to align the lengthwise direction of the terminal 4 in parallel to the vertical direction and locate the terminal 4 below the joint 9. The terminal chain supply unit supplies the terminal chain 10 in a position between the base plate 16 and the horizontal plate 18 so as to transfer intermittently each one of the terminals 4 along a lengthwise direction of the terminal chain 10.

The slide support unit 12, as shown in FIG. 1, includes a linear guide 19, a motor for slide motion 20, and a ball screw (not shown). The linear guide 19 has a rail 22 extending linearly, and a slider 23 arranged at the rail 22 slidably along a lengthwise direction of the rail 22.

The lengthwise direction of the rail 22 intersects (“perpendicular to” in FIG. 1) the lengthwise direction of the joint 9 of the terminal chain 10 supplied by the terminal chain supply unit. The rail 22 is arranged and mounted on the base plate 16. The slider 23 is mounted on a later-described support member 26 of the support unit 13.

A main body of the motor for slide motion 20 is fixed at the apparatus main body 11. An output shaft of the motor for slide motion 20 is arranged in parallel to the lengthwise direction of the rail 22 of the linear guide 19. The ball screw includes a screw shaft extending linearly, and a nut engaged with the screw shaft. The screw shaft is connected to the output shaft of the motor for slide motion 20 and rotated around an axis thereof by the motor for slide motion 20. A lengthwise direction of the ball screw is arranged in parallel to the lengthwise direction of the rail 22 of the linear guide 19, that is a direction intersecting (“perpendicular to” in FIG. 1) the lengthwise direction of the joint 9 of the terminal chain 10. The nut is mounted at the support member 26 of the support unit 13.

The slide support unit 12 supports the support unit 13, that is the slider 23, movably along the direction intersecting (perpendicular to) the lengthwise direction of the joint 9 of the terminal chain 10, and moves the support unit 13 along the rail 22, that is the lengthwise direction of the screw shaft, by rotating the screw shaft around the axis thereof through the output shaft by the motor for slide motion 20.

The support unit 13, as shown in FIG. 1, has the support member 26. The support member 26 is formed into a cuboid shape. The support member 26 is provided with a support recess 27 dented from a top surface of the support member 26. The support recess 27 is formed along an outline of the terminal set jig 2 for receiving the terminal set jig inside the support recess 27 and positioning the terminal set jig 2 at the support member 26. When the support member 26 receives the terminal set jig 2 into the support recess 27 for positioning the terminal set jig 2, the support member 26 positions the terminal set jig 2 to align a lengthwise direction of the receiving section 6 of the support member 26 in parallel to the vertical direction and align a direction of row of receiving sections 6 in parallel to the lengthwise direction of the rail 22 and the screw shaft, that is the direction intersecting (“perpendicular to” in FIG. 1) the lengthwise direction of the terminal chain 10 (joint 9) supplied by the terminal chain supply unit.

The terminal inserting tool set 3, as shown in FIG. 1, is located between the support unit 13 above the base plate 16 and the horizontal plate 18. In short, the terminal inserting tool set 3 is arranged above the support unit 13. The terminal inserting tool set 3 includes a guide tool 28, a positioning tool 29, a pair of cutting tools 30a, 30b, and an inserting tool 31.

The guide tool 28 is mounted on the vertical plate 17 of the apparatus main body 11. The guide tool 28 is arranged above the support unit 13, that is the terminal set jig 2 supported by the support unit 13. The guide tool 28 is provided with a guide slit 32 extending along the vertical direction. The guide slit 32 receives and positions the terminal chain 10 inside the guide slit 28 so as to align the lengthwise direction of the terminal 4 in parallel to the vertical direction. The guide tool 28 is provide with a positioning hole 33 penetrating a portion 28a of the guide tool at a right side in FIG. 1. The positioning hole 33 is located at a position corresponding to the round hole 8 of the terminal chain 10 fed into the guide slit 32, and extends linearly along the rail 22, that is the direction intersecting (“perpendicular to” in FIG. 1) the lengthwise direction of the terminal chain 10.

The positioning tool 29 is located at a left side of the guide tool 28 in FIG. 1, and supported by the vertical plate 17 of the apparatus main body 11 so as to move freely along a direction to be close to and apart from the guide tool 28 [in FIG. 1, the lengthwise direction of the rail 22, that is the direction intersecting (perpendicular to) the lengthwise direction of the terminal chain 10]. The positioning tool 29 is arranged also in line with the guide tool 28 along the horizontal direction.

The positioning tool 29 is provided with a positioning pin 34 projecting toward the guide tool 28. When the positioning tool 29 approaches the guide tool 28, the positioning pin 34 penetrates into both the round hole 8 of the terminal chain 10 and the positioning hole 33 so as to position the terminal chain 10 with relation to the guide tool 28 and the positioning tool 29.

When the positioning tool 29 approaches the guide tool 28, the positioning pin 34 penetrates into the round hole 8 and the positioning hole 33, and thereby the positioning tool 29 positions the terminal chain 10 with relation to the terminal inserting tool set 3 and then holds the terminal chain 10 between the portion 28a of the guide tool 28 and the positioning tool 29.

The pair of cutting tools 30a, 30b is arranged to move freely close to and apart from each other along a direction in parallel to the lengthwise direction of the rail 22 and an intersect direction intersecting (“perpendicular to” in FIG. 1) both the lengthwise direction of the terminal 4 of the terminal chain 10 and the direction of the row of terminals 4 of the terminal chain 10.

One of the cutting tools 30a is arranged slidably with relation to the positioning tool 29 along the intersect direction intersecting (“perpendicular to” in FIG. 1) both the lengthwise direction of the terminal 4 of the terminal chain 10 and the direction of the row of terminals 4 of the terminal chain 10. The other of the cutting tools 30b is arranged slidably with relation to the guide tool 28 along the intersect direction intersecting (“perpendicular to” in FIG. 1) both the lengthwise direction of the terminal 4 of the terminal chain 10 and the direction of the row of terminals 4 of the terminal chain 10.

The pair of cutting tools 30a, 30b holds one of the terminals 4 of the terminal chain 10 therebetween, and can move the holding terminal 4 from a position of the terminal chain 10 to a position at right side in FIG. 1. The pair of cutting tools 30a, 30b moves the one terminal 4 held therebetween of the terminal chain 10 along the intersect direction intersecting (“perpendicular to” in FIG. 1) both the lengthwise direction of the terminal 4 of the terminal chain 10 and the direction of the row of terminals 4 of the terminal chain 10. By moving the one terminal 4 held between the pair of cutting tools 30a, 30b, the one terminal 4 is separated from the joint 9 of the terminal chain 10.

The inserting tool 31 is located above the guide tool 28 vertically in line with the one terminal 4 separated from the terminal chain 10 by the pair of cutting tools 30a, 30b. The inserting tool 31 is formed into a rod shape and a lengthwise direction thereof is aligned in parallel to the vertical direction. The inserting tool 31 approaches the guide tool 28 and pushes the one terminal 4 separated from the terminal chain 10 by the pair of cutting tools 30a, 30b toward the support unit 13, and thereby inserts the one terminal 4 into the receiving section 6 of the terminal set jig 2 supported by the support unit 13.

The actuating unit 14, as shown in FIG. 1, includes a positioning cylinder 35, a pair of cutting cylinders 36a, 36b, and an inserting cylinder 37. The positioning cylinder 35 has a cylinder body 38 and a rod 39 expandable from the cylinder body 38. The cylinder body 38 is fixed on the vertical plate 17 of the apparatus main body 11 so as to arrange the rod 39 expandable along a direction of moving the pair of cutting tools 30a, 30b close to and apart from each other, and a top end of the rod 39 is connected to the positioning tool 29. By expanding the rod 39, the positioning cylinder 35 moves the positioning tool 29 close to the guide tool 28. By retracting the rod 39, the positioning cylinder 35 moves the positioning tool 29 apart from the guide tool 28.

Each of the pair of cutting cylinders 36a, 36b includes a cylinder body 40 and a rod 41 expandable from the cylinder body 40. The cylinder body 40 of one of cutting cylinders 36a is fixed on the positioning tool 29 so as to arrange the rod 41 of the cutting cylinder 36a expandable along the direction of moving the pair of cutting tools 30a, 30b close to and apart from each other, and a top end of the rod 41 of the cutting cylinder 36a is connected to the one of cutting tools 30a. The cylinder body 40 of the other of cutting cylinders 36b is fixed on the vertical plate 17 of the apparatus main body 11 so as to arrange the rod 41 of the cutting cylinder 36b expandable along the direction of moving the pair of cutting tools 30a, 30b close to and apart from each other, and a top end of the rod 41 of the cutting cylinder 36b is connected to the other of cutting tools 30b. By expanding the rods 41 of the pair of cutting cylinders 36a, 36b, the pair of cutting cylinders 36a, 36b moves the pair of cutting tools 30a, 30b close to each other. By retracting the rods 41 of the pair of cutting cylinders 36a, 36b, the pair of cutting cylinders 36a, 36b moves the pair of cutting tools 30a, 30b apart from each other.

The inserting cylinder 37 has a cylinder body 42 and a rod 43 expandable from the cylinder body 42. The cylinder body 42 is fixed on the horizontal plate 18 of the apparatus main body 11 so as to arrange the rod 43 expandable along the vertical direction, and a top end of the rod 43 is connected to the inserting tool 31. By expanding the rod 43, the inserting cylinder 37 moves the inserting tool 31 close to the support unit 13. By retracting the rod 43, the inserting cylinder 37 moves the inserting tool 31 apart from the support unit 13.

The controller 15 includes a processor with RAMs and ROMs, and connects with the terminal chain supply unit, the motor for slide motion 20 at the slide support unit 12, and respective cylinders 35, 36a, 36b and 37 at the actuating unit 14 for controlling respective functions as controlling whole terminal inserting apparatus 1.

The terminal inserting apparatus 1 inserts the terminals 4 into the receiving sections 6 in the terminal set jig 2 as following. Firstly, the terminal set jig 2 is placed in the support unit 13. As shown in FIG. 1, the controller 15 retracts the rods 39, 41 and 43 of the respective cylinders 35, 36a, 36b and 37, and makes the terminal chain supply unit supply the terminal 4 of the terminal chain 10 into the slit 32 of the guide tool 28 so as to position the one terminal 4 at a top end of the terminal chain 10 between the pair of cutting tools 30a, 30b. Thereafter, the controller 15 controls the motor for slide motion 20 so as to move the support unit 13 in a position, in which the receiving section 6 to be firstly inserted is positioned under the one terminal 4 separated from the terminal chain 10 by the pair of cutting tools 30a, 30b.

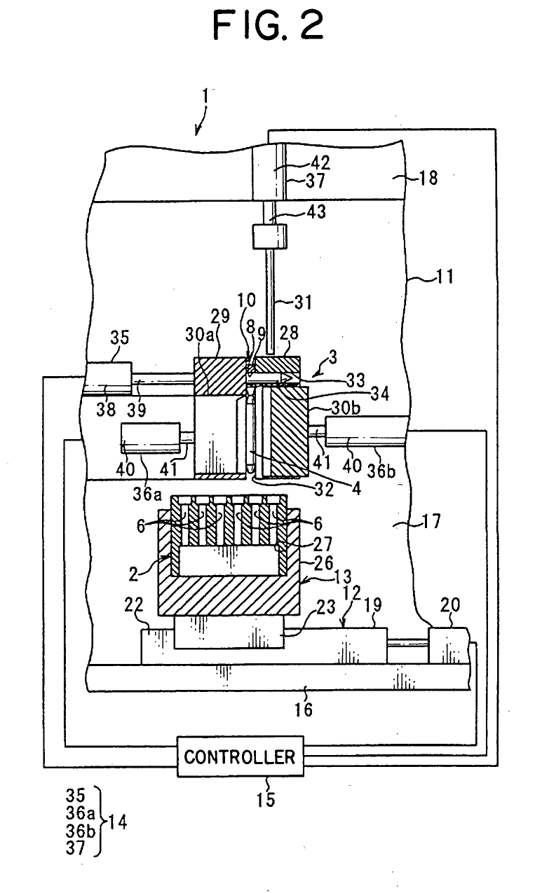

Thereafter, as shown in FIG. 2, the controller 15 expands the rod 39 of the position cylinder 35 so as to penetrate the positioning pin 34 into the positioning hole 33 and the round hole 8, and positions the terminal chain 10 by holding the terminal chain 10 between the portion 28a of the guide tool 28 and the positioning tool 29. The controller 15, as shown in FIG. 3, expands the rod 41 of the other of cutting cylinders 36b so as to make the other of cutting tools 30b abut on the one terminal 4 at the top end of the terminal chain 10.

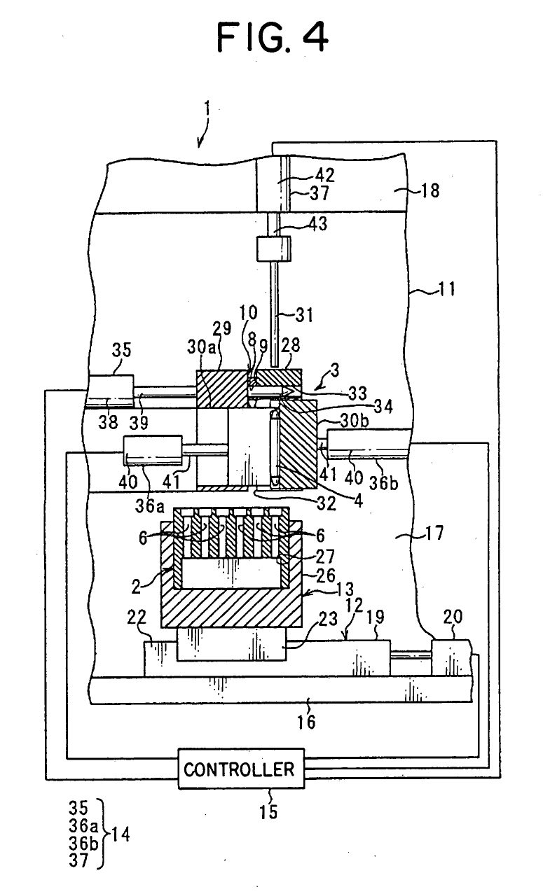

The controller 15, as shown in FIG. 4, expands the rod 41 of the other of cutting cylinders 36a so as to clamp the one terminal 4 at the top end of the terminal chain 10 between the pair of cutting tools 30a, 30b. Then, the controller 15 expands the rod 41 of the one of cutting cylinders 36a and simultaneously retracts the rod 41 of the other of cutting cylinders 36b so as to move the one terminal 4 clamped between the pair of cutting tools 30a, 30b along the intersect direction and separate the one terminal 4 from the joint 9 of the terminal chain 10.

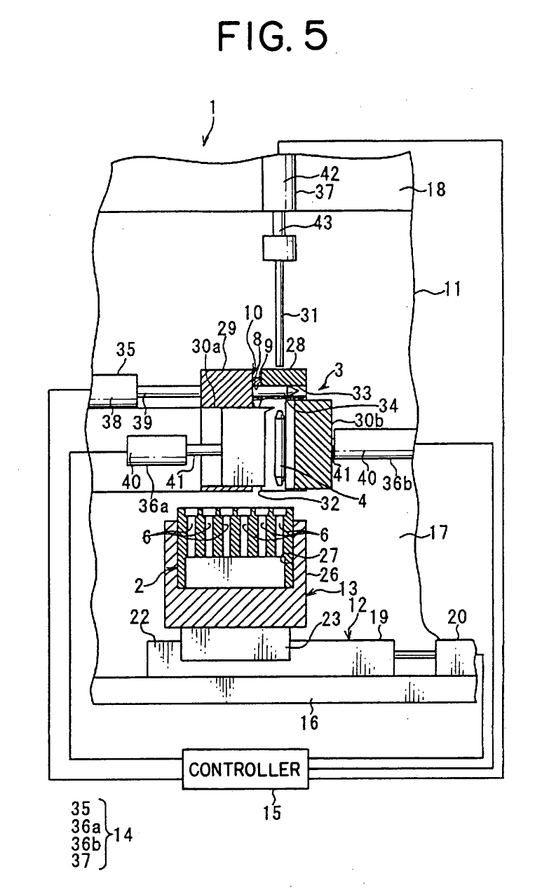

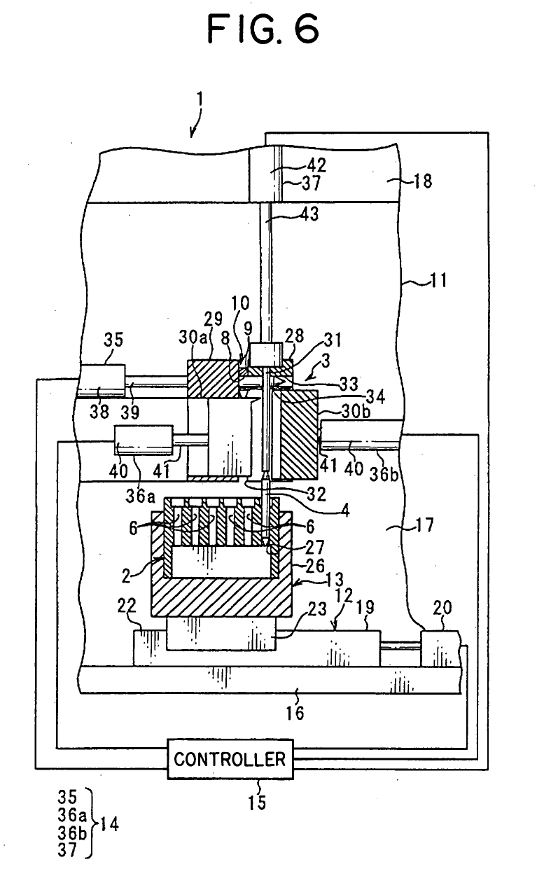

Thereafter, the controller 15, as shown in FIG. 5, slightly retracts the both rods 41 of the pair of cutting cylinders 36a, 36b so as to move the pair of cutting tools 30a, 30b a little apart from the one terminal 4 separated from the terminal chain 10. The controller 15, as shown in FIG. 6, expands the rod 43 of the inserting cylinder 37 so as to press the one terminal 4 separated from the terminal chain 10 toward the support unit 13 and insert the one terminal 4 into the receiving section 6 of the terminal set jig 2 supported by the support unit 13.

After the controller 15 retracts the rods 39, 41, 43 of the respective cylinders 35, 36a, 36b, 37, the controller 15 makes the terminal chain supply unit move another one terminal 4 of the terminal chain 10 over the support unit 13, and controls the motor for slide motion 20 to position the next receiving section 6 to be subsequently inserted under the position, in which the one terminal 4 separated from the terminal chain 10 by the pair of cutting tools 30a, 30b is positioned.

The controller 15 inserts another one terminal 4 into the next receiving section 6 as mentioned above. Thus, the controller 15 holds the terminal chain 10 so as to align the lengthwise direction of the terminals 4 in parallel to the vertical direction, and transfers the terminals 4 along the intersect direction intersecting both the lengthwise direction of the terminals 4 and the direction of the row of the terminals 4, and separates the one terminal 4 from the terminal chain 10, and inserts the one terminal 4 separated from the terminal chain 10 into the receiving section 6.

In this embodiment, after clamping the terminal 4 between the pair of cutting tools 30a, 30b, the terminal 4 is separated from the terminal chain 10 by moving the pair of cutting tools 30a, 30b along the intersect direction intersecting the lengthwise direction of the terminal 4. Thereby, the terminal 4 can be securely separated from the terminal chain 10, in which the lengthwise direction of the terminal 4 is aligned along the vertical direction, and the separated terminal 4 can be securely positioned over the receiving section 6 of the terminal set jig 2 supported by the support unit 13.

Therefore, the terminal 4, the lengthwise direction of which is aligned along the vertical direction, can be easily inserted into the receiving section 6 of the terminal set jig 2. Since the terminal 4 can be easily inserted into the receiving section 6 of the terminal set jig 2 without rotating, the terminal inserting tool set 3 is not required to provide a rotating mechanism so that the terminal inserting tool set 3 can be miniaturized.

Since the terminal inserting tool set 3 includes the positioning tool 29 for positioning the terminal chain 10 by clamping the terminal chain 10 between the guide tool 28 and the positioning tool 29, it can be prevented that the terminal 4 before being separated from the terminal chain 10 is displaced relatively against the cutting tools 30a, 30b. Thereby, the terminal 4 can be securely separated from the terminal chain 10.

Since the terminal inserting apparatus 1 has the aforesaid terminal inserting tool set 3, the terminal 4, the lengthwise direction of which is aligned along the vertical direction, can be easily inserted into the receiving section 6 of the terminal set jig 2 without rotating, so that the terminal inserting tool set 3 is not required to provide any rotating mechanism, and the terminal inserting tool set 3 can be miniaturized.

In the aforesaid embodiment, the support unit 13 is moved with relation to the terminal chain 10 by the slide support unit 12 moving the support unit 13. According to the present invention, only terminal chain 10 can be moved in an intersect direction intersecting (perpendicularly to) the lengthwise direction of the terminal chain 10, or both the support unit 13 and the terminal chain 10 can be moved. In the present invention, by moving at least one of the support unit 12 and the terminal chain 10 in the intersect direction intersecting (perpendicularly to) the lengthwise direction of the terminal chain 10, the support unit 13 can be moved freely with relation to the terminal along the intersect direction intersecting (perpendicularly to) the lengthwise direction of the terminal chain 10. According to the present invention, a connector housing can be used as the terminal holding member instead of the terminal set jig.

### EFFECT OF INVENTION

As described above, according to the present invention, at least one terminal separated from a terminal chain, a lengthwise direction of the terminal of which is aligned along a vertical direction, can be positioned over a corresponding receiving section of a terminal holding member, and thereby the terminal can be easily inserted into the receiving section of the terminal holding member. Therefore, since the terminal can be inserted into the receiving section without rotating, the terminal inserting tool set is not required to provide any rotating mechanism and the terminal inserting tool set can be miniaturized.

According to the present invention, it can be prevented that it can be prevented that the terminal before being separated from the terminal chain is displaced relatively against cutting tools. Thereby, the terminal can be securely separated from the terminal chain.

According to the present invention, since a terminal inserting apparatus has the aforesaid terminal inserting tool set, the terminal can be inserted into the receiving section of the terminal holding member without rotating, so that the terminal inserting tool set is not required to provide any rotating mechanism, and the terminal inserting tool set 3 can be miniaturized.

According to the present invention, since the terminal separated from the terminal chain, the lengthwise direction of the terminal of which is aligned along a vertical direction, can be positioned over the receiving section of the terminal holding member, and thereby the terminal can be easily inserted into the receiving section of the terminal holding member. Therefore, since the terminal can be inserted into the receiving section without rotating, the terminal inserting tool set is not required to provide any rotating mechanism and the terminal inserting tool set can be miniaturized.

While, in the embodiment, an only typical example of the present invention is described, it is not limited thereto. Various change and modifications can be made with the scope of the present invention.

1. A terminal inserting tool set for inserting terminals, which are supplied to the terminal inserting tool set in a form of a terminal chain including the multiple terminals and a joint for connecting continuously the terminals to each other in a row, into receiving sections of a terminal holding member, comprising:
a guide tool positioning the terminal chain so as to align lengthwise directions of the terminals in parallel with a vertical direction;
a pair of cutting tools arranged to freely move close to and apart from each other along an intersect direction intersecting both the lengthwise directions of the terminals and a direction of the row of the terminals, the pair of cutting tools separating at least one terminal of the terminals from the terminal chain by placing the at least one the terminal between the pair of cut tools and moving the at least one the terminal along the intersect direction; and
an inserting tool inserting the at least one terminal separated from the terminal chain by the cutting tools into at least one of the receiving sections of the terminal holding member.

2. The terminal inserting tool set according to claim 1 further comprising a positioning tool positioning the terminal chain by holding the terminal chain between the positioning tool and the guide tool.

3. A terminal inserting apparatus, comprising:
an apparatus main body;
a supporting unit provided in the apparatus main body and supporting the terminal holding member;
the terminal inserting tool set claimed in claim 1, the terminal inserting tool set arranged above the supporting unit and inserting the one terminal into the one of the receiving sections of the terminal holding member; and
an actuating unit actuating the terminal inserting tool set.

4. A terminal inserting apparatus, comprising:
an apparatus main body;
a supporting unit provided in the apparatus main body and supporting the terminal holding member;
the terminal inserting tool set claimed in claim 2, the terminal inserting tool set arranged above the supporting unit and inserting the one terminal into the one of the receiving sections of the terminal holding member; and
an actuating unit actuating the terminal inserting tool set.

5. A method of inserting terminals into receiving sections of a terminal holding member, comprising the steps of:
supplying the terminals in a form of a terminal chain having the multiple terminals and a joint for connecting continuously the terminals to each other in a row;
positioning the terminal chain so as to align lengthwise directions of the terminals parallel to a vertical direction;
moving at least one terminal of the terminals along an intersect direction intersecting both the lengthwise directions of the terminals and a direction of the row of the terminals;
separating the at least one terminal from the terminal chain; and
inserting the at least one terminal into at least one of the receiving sections of the terminal holding member.
